(19) United States
(12) Patent Application Publication
(10) Pub. No.: US 2008/0088592 A1
(43) Pub. Date: Apr. 17, 2008

(54) Contamination detection in touch based sensor arrays

(75) Inventor: Charles David Fry, New Bloomfield, PA (US)

Correspondence Address: HELEN ODAR WOLSTONCROFT;Tyco Electronics Corporation, Suite 140, 4550 New Linden Hill Road, Wilmington, DE, 19808-2952, US

(73) Assignee: Tyco Electronics Corporation

(21) Appl. No.: 11/545,920

(22) Filed: Oct. 11, 2006

(51) Int. Cl. G06F 3/041

(52) U.S. Cl. 345/173

(57) ABSTRACT

A touch based control system for a device includes a first sensor and a second sensor proximate the first sensor. At least one of the first and second sensors includes a touch sensitive area associated therewith. A controller is coupled to the first and second sensors. The controller monitors detected activations of the first and second sensors. The controller is configured to distinguish between an activation resulting from a touch to the touch sensitive area and an activation resulting from contamination between the first and second sensors. Further, a method for detecting contamination in a sensor array is provided that includes selecting a sensor as the active sensor, pulsing the selected sensor, and if a response is detected during the pulse to the selected sensor, the pulse to the selected sensor is repeated and the non-selected sensors are checked for a response after the pulse.

### BACKGROUND OF THE INVENTION

The invention relates generally to touch sensitive control interfaces, and more particularly, to methods and apparatus for detecting surface contamination on such interfaces.

Due to their convenience and reliability, touch sensitive control interfaces are increasingly being used in lieu of mechanical switches for various products and devices. Touch sensitive control interfaces are used in a wide variety of exemplary applications such as appliances (e.g., stoves and cooktops), industrial devices such as machine controls, cash registers and check out devices, vending machines, and even toys. The associated device may be finger operated by touching predefined areas of the interface, and the device typically includes a controller coupled to the interface to operate mechanical and electrical elements of the device in response to user commands entered through the touch control interface. The control interface may be a single touch sensor or a multi-sensor array. The multi-sensor array provides a keyboard or keypad type interface as opposed to a single switch interface.

Some touch sensors attempt to detect touches by measuring a change in capacitance at the touch interface. The capacitances involved, however, are tiny, and the methods of measuring capacitance tend to be easily affected by noise or surface contamination, particularly in the case of multi-sensor arrays where contamination may cross multiple sensors and cause a false detection at a sensor. Such false detections at a sensor could cause a device to inadvertently turn on. The sensors or keypads are typically covered with a lexan, glass, acrylic, or other such material. However, contaminates, particularly moisture from a spill, may sometimes get behind the cover and come in contact with the sensors.

It would be desirable to provide a touch based sensor system that can reliably distinguish between an actual user touch and a false touch resulting from contamination at the sensor.

### BRIEF DESCRIPTION OF THE INVENTION

In one aspect, a touch based control system for a device is provided. The touch based control system includes a first sensor and a second sensor proximate the first sensor. At least one of the first and second sensors includes a touch sensitive area associated therewith. A controller is coupled to the first and second sensors. The controller monitors detected activations of the first and second sensors. The controller is configured to distinguish between an activation resulting from a touch to the touch sensitive area and an activation resulting from contamination between the first and second sensors.

Optionally, the controller includes a microprocessor having a digital algorithm configured to distinguish between an activation resulting from a touch to the touch sensitive area and an activation resulting from contamination between the first and second sensors. Alternatively, the controller may include an analog circuit configured to distinguish between an activation resulting from a touch to the touch sensitive area and an activation resulting from contamination between the first and second sensors. Each of the first and second sensors includes a sensor circuit having an op amp and wherein the controller if configured to examine an output of the op amp to identify an op amp output resulting from contamination between the first and second sensors.

In another aspect, a method for detecting contamination in a touch based sensor array is provided. The method includes selecting a sensor as the active sensor, pulsing the selected sensor, and checking for a response from the selected sensor during the pulse. When a response is detected during the pulse, the method continues with repeating the pulse to the selected sensor, checking for a response from a non-selected sensor after the pulse to the selected sensor, and giving a notification of contamination between the selected and non-selected sensors when a response is detected from the non-selected sensor after the pulse to the selected sensor.

### BRIEF DESCRIPTION OF THE DRAWINGS

FIG. 1 is a schematic block diagram of an exemplary touch sensitive control system for a device.

FIG. 2 is a circuit schematic of the touch sensor and touch controller shown in FIG. 1.

FIG. 3 illustrates pulse-to-op amp responses for the circuit shown in FIG. 2 with no touches.

FIG. 4 illustrates pulse-to-op amp responses for the circuit shown in FIG. 2 with one sensor touched.

FIG. 5 illustrates pulse-to-op amp responses for the circuit shown in FIG. 2 with two sensors touched.

FIG. 6 illustrates pulse-to-op amp responses for the circuit shown in FIG. 2 with contamination between the sensors.

FIG. 7 illustrates a flow diagram for an algorithm for contamination detection according to an exemplary embodiment of the present invention.

### DETAILED DESCRIPTION OF THE INVENTION

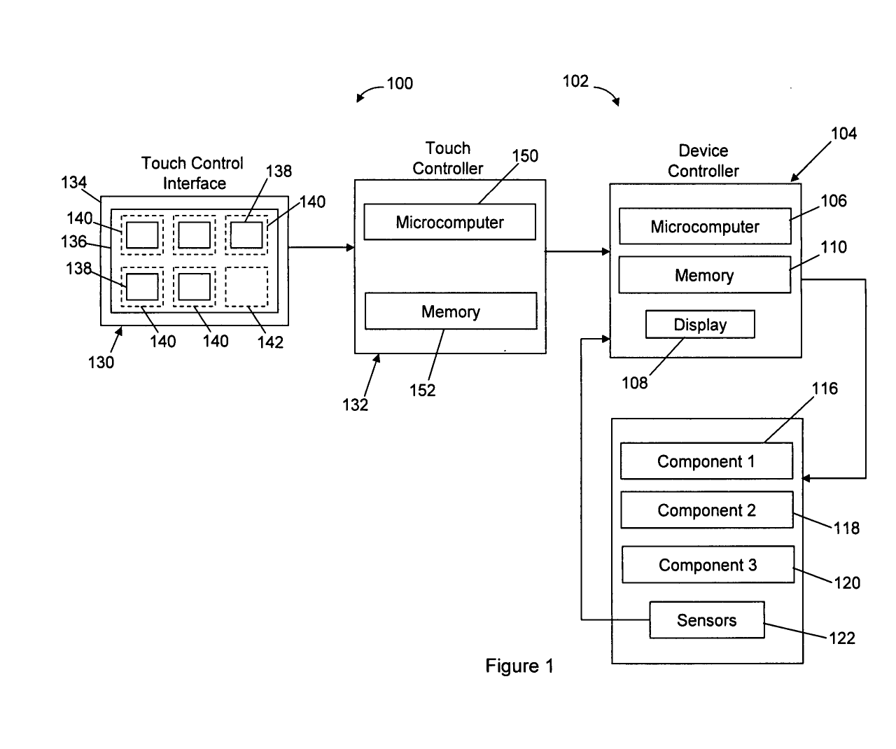

FIG. 1 illustrates a schematic block diagram of an exemplary touch sensitive control system 100 for a device 102, which in various embodiments may be an appliance, an industrial machine or any other device in which a touch sensitive control interface is desirable.

In an exemplary embodiment, device 102 includes a device controller or microcontroller 104 which may, for example, include a microcomputer or other processor 106 and a display 108 to display appropriate messages and/or indicators to the operator of the device 102 to confirm user inputs and operation of the device 102. A memory 110 is also coupled to the device controller 104 and stores instructions, calibration constants, and other information as required to satisfactorily complete a selected user instruction or input. The memory 110 may, for example, be a random access memory (RAM). In alternative embodiments, other forms of memory could be used in conjunction with RAM memory, including but not limited to flash memory (FLASH), programmable read only memory (PROM), and electronically erasable programmable read only memory (EEPROM).

Analog to digital and digital to analog converters (not shown) are coupled to the device controller 104 to implement controller inputs and executable instructions to generate controller outputs to operative components 116, 118 and 120 of the device 102 according to known methods. While three components 116, 118, and 120 are illustrated in FIG. 1, it is recognized that greater or fewer components may be employed within the scope of the present invention. The device controller 104 monitors various operational factors of the device 102 with one or more sensors or transducers 122, and the device controller 104 executes operator selected functions and features according to known methods.

The touch sensitive control system 100 includes a touch control interface 130 and a touch controller or touch microcontroller 132. An operator may enter control parameters, instructions, or commands and select desired operating algorithms and features of the device 102 via the touch control interface 130.

The touch control interface 130 includes a panel 134 that defines an interface area 136 for manipulation by a user to enter control commands and instructions for the device 102. In different embodiments, the panel 134 may be mounted proximate the operative components 116-120 (e.g., cooking elements) of the device 102 (such as in a range), or the panel 134 may be located in a remote location from the components 116-120 (such as for moving components of an industrial machine).

The interface area 136 includes one or more touch sensitive areas or touch pads 138 for user selection and manipulation to enter commands to operate the device 102. While five touch sensitive areas 138 are provided in the illustrated embodiment, it is to be understood that more or fewer touch sensitive areas 138 may be included in the interface area 136 in alternative embodiments. A touch sensor element or touch sensor 140 (shown in phantom in FIG. 1) is associated with each touch sensitive area 138. In some embodiments, one or more additional sensor elements 142 may be located in the interface area 136. The additional sensor elements 142, if present, may be identical to the touch sensors 140, however, the additional sensor elements 142 are not associated with a touch sensitive area such as the touch sensitive areas 138. The sensor elements 140, 142 may be arranged in rows and columns to form a sensor array.

The touch sensors 140 and the touch controller 132 are configured to detect an actual touch at the associated touch sensitive areas or touch pads 138. Such events are also referred to herein as an activation of the sensors 140. The touch controller 132, is in communication with each of the sensors 140 and, if present, the sensors 142. The touch controller 132 is also operationally connected to the device controller 104. Like the device controller 104, the touch controller 132 may also be referred to as a microcontroller and includes a microcomputer 150 or other processor coupled to the touch control interface 130, and a memory 152 that stores instructions, calibration constants, control algorithms, and other information as required to satisfactorily interface with the device controller 104. The memory 152 may, for example, be a random access memory (RAM). In alternative embodiments, other forms of memory could be used in conjunction with RAM memory, including but not limited to flash memory (FLASH), programmable read only memory (PROM), and electronically erasable programmable read only memory (EEPROM). In an exemplary embodiment, the touch controller 132 may perform such functions as contamination detection as will be described. While the touch controller 132 is separately illustrated in FIG. 1 as being separate from the device controller 104, it is contemplated that the functionality of the touch controller 132 could be integrated into the device controller 104 in other embodiments, and a dedicated touch controller 132 is therefore considered optional to the present invention.

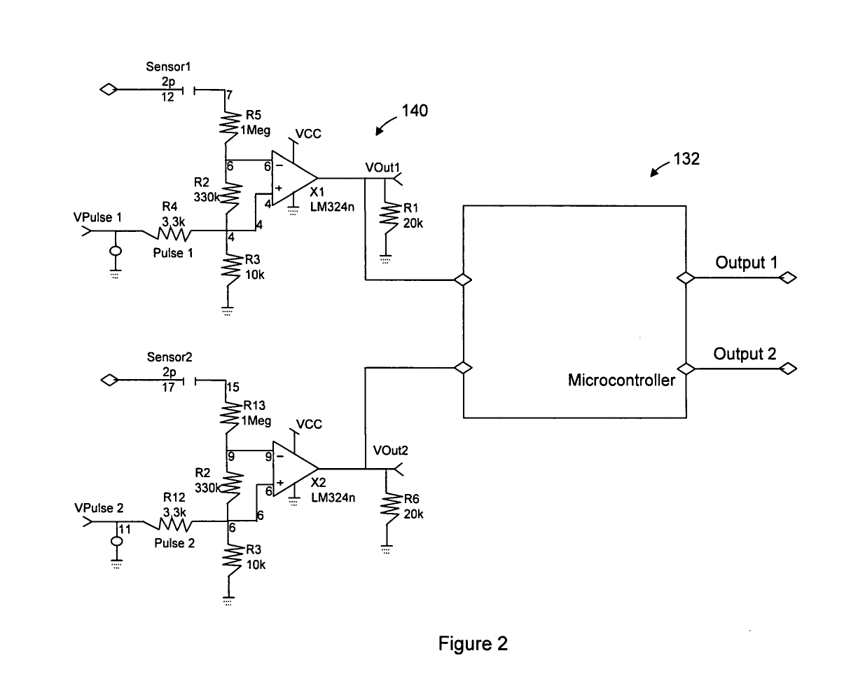

FIG. 2 is a circuit schematic of the touch sensor 140 and touch controller 132 of the touch sensitive control system 100. More specifically, FIG. 2 represents a circuit schematic for a control system having two sensor elements 140. The sensor circuit of FIG. 2 may be expanded as necessary for the total number of sensor elements 140 used in the touch sensitive control system 100. The sensor circuits are substantially identical to one another and therefore only one sensor circuit is described in detail below. The operation of a single touch sensor circuit similar to the circuit illustrated in FIG. 2 is described in detail in U.S. patent application Ser. No. 11/190,759 filed Jul. 27, 2005 titled “Touch Sensor Circuitry and System”, the complete disclosure of which is hereby incorporated in its entirety.

Sensor circuit 1 includes Sensor1 which may be a capacitive touch sensor element as is known in the art, resistors R1, R2, R3, R4, and optionally R5, an op amp X1, and a pulse voltage generator, Pulse1. Though Sensor1 is shown as a capacitance, other methods of coupling are possible. In some embodiments, the pulse voltage may be generated by the controller 132. In this circuit, resistor R1 is provided as a load to the op amp X1, and its value is set by the needs of the op amp X1. Resistor R3 is a biasing resistor providing a reference for op amp X1. Resistor R4 is provided to reduce the output of Pulse1 to a level that will avoid saturation on the inputs of op amp X1. Resistor R2 is a current sensing resistor. Resistor R5 is an impedance matching resistor.

When a touch sensitive area or touch pad 138 (FIG. 1) is touched, a current will flow through Sensor1 during a pulse from Pulse1. The voltage across resistor R2 resulting from the Sensor 1 current is amplified by X1. In some embodiments, R5 is used to impedance match the circuit to Sensor1 plus a finger. Impedance matching has the affect of increasing the peak current flow through Sensor1. If there is not a finger touching the touch pad 138, a significantly lower current will flow through the Sensor1. The touch controller 132 transmits outputs to the device controller 104 (FIG. 1) based on touch detections or activations of the sensors 140. An actual touch at the touch pads 138 generates signals VOut1 and VOut2 at the X1 and X2 op amp outputs, respectively. However, surface contamination between or across two sensors may also generate a signal at the X1 and X2 op amp outputs VOut1 and VOut2 as described below.

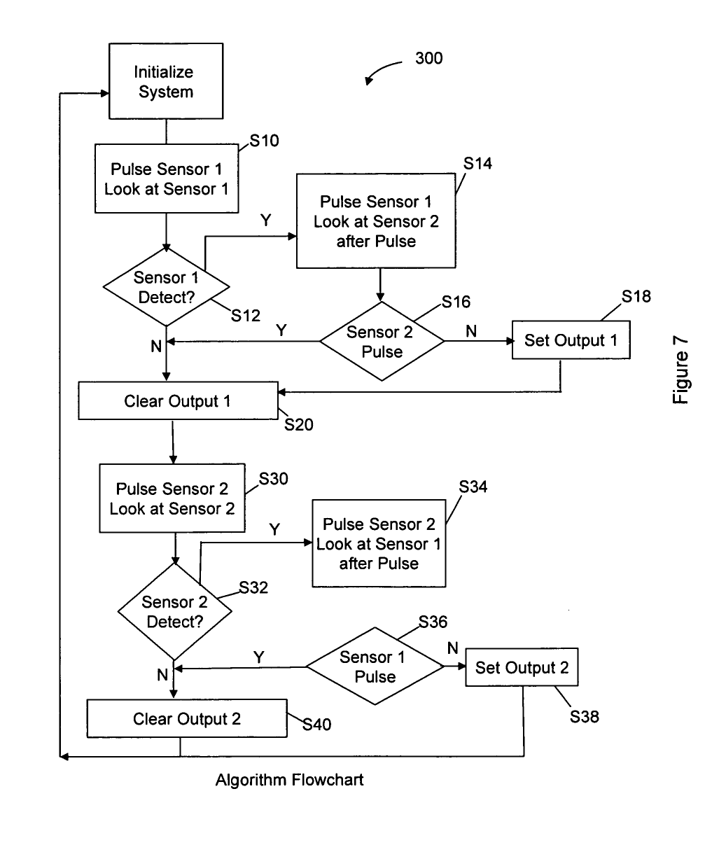

The touch controller 132 processes the signals from the sensor circuits 140 using the algorithm shown in FIG. 7. The outputs of the touch controller 132, Output1 and Output2, indicate valid touches on the appropriate touch sensor 140 via touch pad 138. The output format of the touch controller 132 is application specific and is not a limitation of the invention. The touch controller output, Output1 and Output2 can be anything appropriate for the application including, but not limited to: discrete signals as shown, a serial interface, parallel interface, or internal use only when the touch controller 132 is used for more than just touch control processing. In exemplary embodiments, the touch controller 132 includes more resources than are necessary for the functions described above.

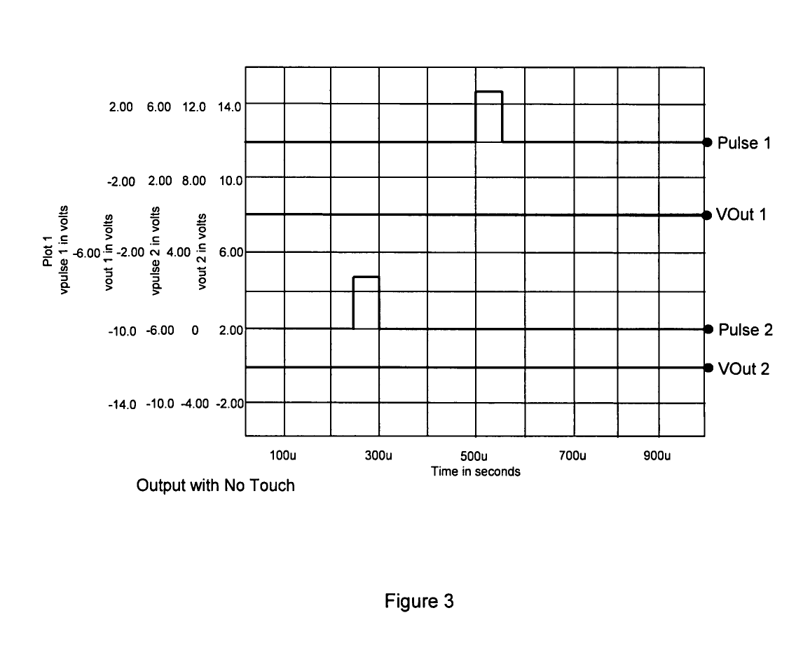

FIG. 3 illustrates pulse-to-op amp responses for the two-sensor circuit shown in FIG. 2 with no touches to the touch pads 138. As shown, when no touch pad 138 is touched, the outputs VOut1 and VOut2 are constant and approximately zero.

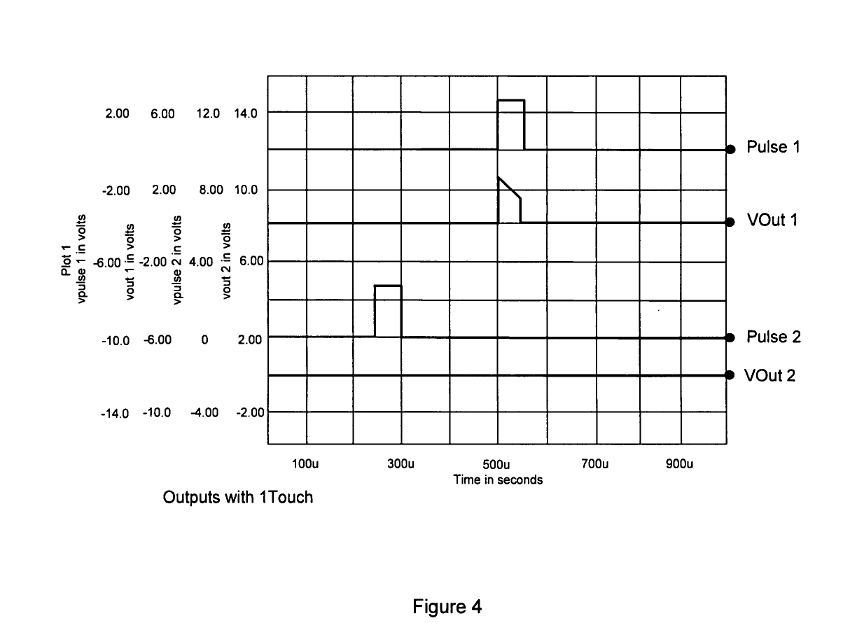

FIG. 4 illustrates pulse-to-op amp responses for the two-sensor circuit shown in FIG. 2 with a touch to the touch pad 138 for the Sensor1 circuit. As shown, when the touch pad 138 for Sensor1 is touched, a VOut1 output is detected that occurs substantially within the time duration of the pulse Pulse1. In the Sensor2 circuit, the VOut2 output is constant and approximately zero in response to both the Pulse1 and Pulse2 pulses.

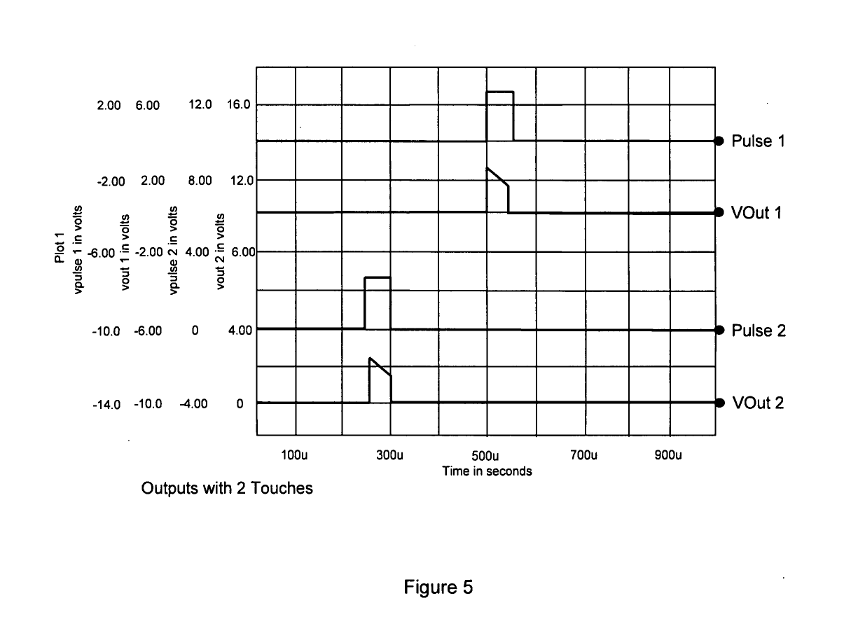

FIG. 5 illustrates pulse-to-op amp responses for the two-sensor circuit shown in FIG. 2 with a touch to the touch pads 138 for the Sensor1 and Sensor2 circuits. As shown, when the touch pad 138 for Sensor1 is touched, a VOut1 output is detected that occurs substantially within the time duration of the Pulse1 pulse. No VOut1 response is detected in response to Pulse2. In the Sensor2 circuit, when a touch pad 138 for Sensor2 is touched, a VOut2 output is detected that occurs substantially within the period or time duration of the Pulse2 pulse, while no VOut2 response is detected in response to Pulse1.

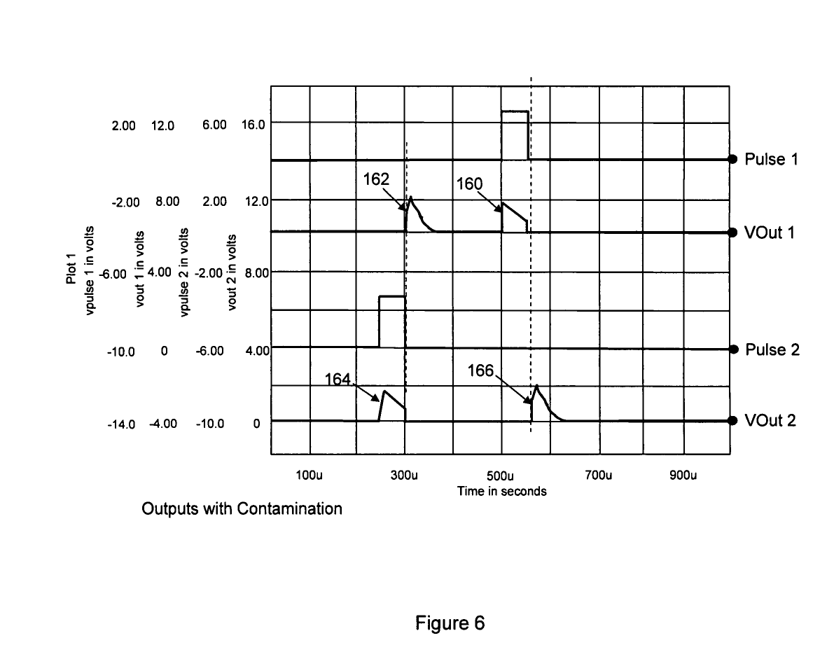

FIG. 6 illustrates pulse-to-op amp responses for the two-sensor circuit shown in FIG. 2 with contamination between the sensors Sensor1 and Sensor2. When contamination is present, there is a cross-coupling of the Sensor1 and Sensor2 circuits. The Sensor1 circuit shows a response 160 at VOut1 that occurs within the time duration of Pulse1. Due to the contamination, an additional response 162 occurs at VOut1 after the Pulse2 pulse. Similarly, with regard to Sensor2, a response 164 at VOut2 occurs within the time duration of Pulse2 touch pad 138. Due to the contamination, an additional response 166 occurs at VOut2 after the Pulse1 pulse. The presence of the post pulse responses 162 and 166 can be used to detect the presence of contamination between the sensors 140 and to distinguish between a detection or activation due to an actual touch, and a detection or activation due to contamination. Further, the presence of the post pulse responses 162 and 166 can be used to detect the presence of contamination between the touch sensor 140 and the sensor 142 not having a touch pad, and to distinguish between a detection or activation due to an actual touch and a detection or activation due to contamination between the sensors 140 and 142.

FIG. 7 illustrates a flow diagram for an algorithm 300 for contamination detection according to an exemplary embodiment of the present invention. In one embodiment, the algorithm 300 may be implemented as a digital algorithm that is executed by the touch controller 132. In alternative embodiments, the algorithm 300 may be implemented as an analog circuit. With reference to FIGS. 2 and 7, the algorithm 300 as shown corresponds to a two-sensor circuit and may be expanded as necessary for circuits including more sensor elements 140, 142. The algorithm examines pulse responses and post pulse behavior to detect the presence of surface contamination between two or more sensor elements 140, 142 in the interface area 136 (FIG. 1) or sensor array. In single sensor applications, an additional sensor 142 not associated with a touch pad 138 (FIG. 1) may be placed proximate the single sensor 140 to enable contamination detection on the single sensor 140. In exemplary embodiments, the algorithm 300 may either ignore detected activations resulting from contamination or give a notification that contamination exists, or both. In some embodiments, the algorithm may also identify the sensors 140 that are contaminated.

After the system is initialized, the algorithm 300 begins at step S10 by selecting the first sensor, Sensor1 as the active sensor and pulsing Sensor1. At step S12, the op amp output VOut1 is checked for a response during the pulse. If a response or activation is detected, processing continues at step S14 where the pulse to Sensor1 is repeated. At step S16, the inactive sensor, Sensor2 is checked for a post pulse response after the repeated pulse to Sensor1. If no post pulse response is detected at VOut2, processing continues at step S18 where a valid touch at Sensor1 is considered to have occurred and an Output1 signal is set and passed to the device controller 104 (FIG. 1). If at step S16, a post pulse response is detected at VOut2, contamination is found and processing continues at step S20 where Output1 is cleared and no Output1 signal is set. If at step S12, no response during the pulse is detected, there has been no touch at Sensor1 and Output1 is cleared at step S20. After either of steps S18 or S20, processing continues at step S30.

At step S30, Sensor2 is selected as the active sensor and Sensor2 is pulsed. At step S32, the op amp output VOut2 is checked for a response during the pulse. If a response or activation is detected, processing continues at step S34 where the pulse to Sensor2 is repeated. At step S36, the inactive sensor, now Sensor1, is checked for a post pulse response after the repeated pulse to Sensor2. If no post pulse response is detected at VOut1, processing continues at step S38 where a valid touch at Sensor2 is considered to have occurred and an Output2 signal is set and passed to the device controller 104 (FIG. 1). If at step S36, a post pulse response is detected at VOut1, contamination is found and processing continues at step S40 where Output2 is cleared and no Output2 signal is set. If at step S32, no response during the pulse is detected, there has been no touch at Sensor2 and Output2 is cleared at step S40. After either of steps S38 or S40, processing is repeated starting at step S10. An alternative embodiment would use a single pulse per sensor and look for both the activation response and the contamination response on that single pulse.

In larger sensor arrays, each sensor 140 in the array is, in turn pulsed as the active sensor. If a response during the pulse is detected, then the steps S14-S16 are repeated on an iterative basis for each remaining sensor in the array. If no post pulse activity is detected for any of the remaining sensors, then a valid touch is considered to have occurred and the appropriate output signal is set and passed to the device controller 104 (FIG. 1). Otherwise contamination is found. The next sensor is then pulsed as the active sensor and the process is repeated. In some embodiments, an active sensor 140 is determined by pulsing each sensor 140 in the array until a response from the pulse is detected and selecting the responding sensor 140 as the active sensor.

The embodiments thus described provide a touch based control system that distinguishes between sensor activations resulting from a touch to a touch pad and activations resulting from the presence of surface contamination between two or more sensors in a sensor array. The contamination is detected by selecting each sensor, in turn, as the active sensor and then examining the post pulse responses of the remaining sensors. If a post pulse response is detected, then a connection between the sensors exists and the activation can be attributed to surface contamination between two or more sensors.

Although the currently described embodiment is shown with a capacitive coupled sensor, the sensor coupling could be of various other forms including inductive and resistive. Any touch system that measures the change in transferred energy due to a touch might potentially be adapted to use this contamination detection method. This method relies on the coupling of energy from one sensor to an adjacent sensor.

While the invention has been described in terms of various specific embodiments, those skilled in the art will recognize that the invention can be practiced with modification within the spirit and scope of the claims.

What is claimed is:

1. A touch based control system for a device, said touch based control system comprising:
a first sensor and a second sensor proximate said first sensor, at least one of said first and second sensors including a touch sensitive area associated therewith; and
a controller coupled to said first and second sensors and monitoring detected activations of said first and second sensors, and wherein said controller is configured to distinguish between an activation resulting from a touch to said touch sensitive area and an activation resulting from contamination between said first and second sensors.

2. The touch based control system of claim 1, wherein said controller comprises a microprocessor including a digital algorithm configured to distinguish between an activation resulting from a touch to said touch sensitive area and an activation resulting from contamination between said first and second sensors.

3. The touch based control system of claim 1, wherein said controller includes an analog circuit configured to distinguish between an activation resulting from a touch to said touch sensitive area and an activation resulting from contamination between said first and second sensors.

4. The touch based control system of claim 1, wherein said controller is configured to repetitively pulse said first and second sensors.

5. The touch based control system of claim 1, wherein each of said first and second sensors comprises a sensor circuit including a pulse generator to drive said sensor circuit.

6. The touch based control system of claim 1, wherein each of said first and second sensors comprises a sensor circuit including an op amp and wherein said controller if configured to examine an output of said op amp to identify an op amp output resulting from contamination between said first and second sensors.

7. The touch based control system of claim 1, wherein said controller is configured to generate output signals indicative of a touch to said touch sensitive area when the controller detects a touch to the touch sensitive area.

8. The touch based control system of claim 1, wherein said controller is configured to be electrically coupled to a device controller in the device.

9. The touch based control system of claim 1, wherein each of said first and second sensors comprises a sensor circuit including an op amp, a pulse generator to drive the circuit, and a resistance configured to reduce the output of the pulse generator to a level that inhibits saturation of an input to the op amp.

10. A method for detecting contamination in a touch based sensor array, the method comprising:
selecting a sensor as the active sensor;
pulsing the selected sensor;
checking for a response from the selected sensor during the pulse;
repeating the pulse to the selected sensor when a response is detected during the pulse;
checking for a response from a non-selected sensor after the pulse to the selected sensor; and
giving a notification of contamination between the selected and non-selected sensors when a response is detected from the non-selected sensor after the pulse to the selected sensor.

11. The method of claim 10, wherein checking for a response from the selected sensor further comprises clearing a selected sensor output when no response is detected during the pulse.

12. The method of claim 10, wherein checking for a response from a non-selected sensor further comprises iteratively checking all non-selected sensors for a response after the pulse to the selected sensor.

13. The method of claim 10, wherein giving a notification of contamination further comprises clearing a selected sensor output when a response is detected from the non-selected sensor after the pulse to the selected sensor.

14. The method of claim 10, wherein giving a notification of contamination further comprises identifying the selected and non-selected sensors that are contaminated.

15. The method of claim 10, wherein checking for a response from a non-selected sensor further comprises setting the selected sensor output to indicate a valid touch when no response is detected from the non-selected sensor after the pulse to the selected sensor.

16. The method of claim 10, wherein selecting a sensor as an active sensor includes pulsing each sensor in the array until a response from the pulse is detected and selecting the responding sensor as the active sensor.
